(19) United States
(12) Patent Application Publication
(10) Pub. No.: US 2020/0038955 A1
(43) Pub. Date: Feb. 6, 2020

(54) REACTIVE PRECURSORS FOR UNCONVENTIONAL ADDITIVE MANUFACTURED COMPONENTS

(71) Applicant: Lawrence Livermore National Security, LLC, Livermore, CA (US)

(72) Inventors: Jason R. Jeffries, Livermore, CA (US); Kiel S. Holliday, Livermore, CA (US)

(21) Appl. No.: 16/530,467

(22) Filed: Aug. 2, 2019

Related U.S. Application Data
(60) Provisional application No. 62/714,529, filed on Aug. 3, 2018.

(51) Int. Cl. B22F 3/105; B29C 64/10

(52) U.S. Cl. CPC B22F 3/1055; B33Y 10/00; B29C 64/10

(57) ABSTRACT

A product includes a metallic and/or ceramic three-dimensional structure having physical characteristics of formation by additive manufacturing. The structure has random porosity within filaments thereof. A method includes printing a structure by extruding an ink thereby creating a printed structure. The ink includes a precursor that is reactive under predefined conditions to form a metallic and/or ceramic material. The method also includes applying the predefined conditions to the printed structure for causing the precursor to react thereby forming a secondary structure of the metallic and/or ceramic material. A method includes applying focused light in a predefined pattern to a composition comprising a precursor that is reactive under influence of the focused light to form a structure of a metallic and/or ceramic material.

The United States Government has rights in this invention pursuant to Contract No. DE-AC52-07NA27344 between the United States Department of Energy and Lawrence Livermore National Security, LLC for the operation of Lawrence Livermore National Laboratory.

### FIELD OF THE INVENTION

The present invention relates to additive manufacturing, and more particularly, this invention relates to using reactive precursors to create unconventional additive manufactured components.

### BACKGROUND

Currently, industrial production of materials is driven by conventional metallurgical techniques like casting, machining, rolling, injection molding, etc. These tools are acceptable for producing metal or plastic parts, but fall short in capability for creating complex ceramic components. Ceramic components comprising light elements can offer exceptional strength-to-weight ratios, potentially enabling advanced uses in the automotive, aerospace, and computing industries. However, ceramic materials are difficult to shape and form, thus these materials have tended to have limited use in industry. For instance, many ceramic components do not melt, and thus forming of ceramic parts tends to be limited to powder processes. These processes involve pressing and sintering ceramic powder which produces only simple shapes of ceramics. A new method of manufacture is desirable to catapult ceramic material into industrial use so that ceramics are utilized and compete with metals and plastics.

Additive manufacturing of ceramic feedstocks is not a straightforward process. Materials like boron-nitride and silicon-nitride do not melt; rather these materials decompose, so it has not been possible to apply bulk or localized melting techniques to produce components of these materials. Thus, methods to adapt additive manufacturing to the production of ceramic materials remain elusive.

### SUMMARY

A product, according to one approach, includes a metallic and/or ceramic three-dimensional structure having physical characteristics of formation by additive manufacturing. The structure has random porosity within filaments thereof.

A method, according to one approach, includes printing a structure by extruding an ink thereby creating a printed structure. The ink includes a precursor that is reactive under predefined conditions to form a metallic and/or ceramic material. The method also includes applying the predefined conditions to the printed structure for causing the precursor to react thereby forming a secondary structure of the metallic and/or ceramic material.

A method, according to one approach, includes applying focused light in a predefined pattern to a composition comprising a precursor that is reactive under influence of the focused light to form a structure of a metallic and/or ceramic material.

Other aspects and approaches of the present disclosure will become apparent from the following detailed description, which, when taken in conjunction with the drawings, illustrate by way of example the principles of the disclosure.

### BRIEF DESCRIPTION OF THE DRAWINGS

FIG. 1 is a flowchart of a method, according to one approach.

FIG. 2 is a flowchart of a method, according to one approach.

FIG. 3 is a schematic drawing of reactive precursors SiO₂+C in a nitrogen atmosphere, according to one approach.

FIG. 4 is a plot of the X-ray diffraction pattern of a boron nitride product resulting from a furnace-enabled reaction of boron oxide and urea powder, according to one approach.

FIG. 5 is a plot of the X-ray diffraction results of the product of a laser-heated mixture of boron oxide and urea powders showing partial conversion to boron nitride, according to one approach.

### DETAILED DESCRIPTION

The following description is made for the purpose of illustrating the general principles of the present disclosure and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred configurations of using reactive precursors for creating unconventional additively manufactured components and/or related systems, methods, and products.

In one general approach, a product includes a metallic and/or ceramic three-dimensional structure having physical characteristics of formation by additive manufacturing. The structure has random porosity within filaments thereof.

In another general approach, a method includes printing a structure by extruding an ink thereby creating a printed structure. The ink includes a precursor that is reactive under predefined conditions to form a metallic and/or ceramic material. The method also includes applying the predefined conditions to the printed structure for causing the precursor to react thereby forming a secondary structure of the metallic and/or ceramic material.

In yet another general approach, a method includes applying focused light in a predefined pattern to a composition comprising a precursor that is reactive under influence of the focused light to form a structure of a metallic and/or ceramic material.

Additive manufacturing (AM) tools offer unique methods of assembly (e.g., produce complex geometries) of industrial parts over traditional production methods like machining, rolling, or casting. AM techniques for conventional materials utilize feedstock material that has relative ductility and can produce a part from a melt. Advanced, functional materials often have properties that exclude them from AM techniques. For instance, hard and brittle ceramics are difficult to produce in complex geometries for industrial applications.

Additive manufacturing techniques may open new avenues for material production by providing local mesostructural control that may be combined with local heating. Specifically, according to various configurations described herein, reactive precursor feedstocks may allow simultaneous synthesis and fabrication of components. These reactive precursors could provide valuable efficiencies for some materials, and revolutionize the production of materials not amenable to current metallurgical techniques.

Currently available commercial additive manufacturing machines include powder bed laser fusion, or selective laser melting/sintering processes that include powder feedstock material. In some applications, the powder is fine with a size in a range of 50 microns or smaller. A high energy laser is scanned in a raster pattern across the powder, in the case of most processes, as the laser scans; the laser melts the metal powder into a solid, continuous metal with a powder background. In subsequent steps, powder is added to the melted region, and a structure is built in a stack, layer by layer. In these conventional processes, the feedstock powder forms a product of the same chemical formulation. For example, a powder of steel may be processed by powder bed laser fusion into a steel structure.

In various configurations described herein, an additive manufacturing process is modified such that the powder feedstock is replaced by precursor feedstocks, single- or multi-component mixtures that are different chemically from the intended final product. In one approach, the feedstock powders are used with a high energy laser to produce a structure composed of a compound that has a different chemical formulation than the precursor feedstocks.

In various configurations, an additive manufacturing process includes reactive precursor feedstocks that form a geometric complex shape that transforms under a high heat stimulus (e.g., laser, sintering, etc.) to a desired compound having a different chemical formulation from the precursor feedstock. In some approaches, in addition to building a specific three-dimensional shape with complex geometries, the laser stimulus synthesizes a new material from a chemical reaction of the reactive feedstock materials.

For example, formation of a ceramic component (e.g., boron carbide, boron nitride, silicon nitride, silicon carbide, etc.) by conventional fabrication methods is limited to the formation of simple structures, e.g., a hockey puck-like structure, because some ceramics decompose rather than melt, prohibiting any pouring operations associated with conventional casting or injection molding. Moreover, the melt temperatures of ceramics are very high.

According to various configurations, additive manufacturing combined with reactive precursors may allow fabrication of difficult-to-produce materials. Before the advent of additive manufacturing, chemical reactions of reactive precursors would have resulted in only powdered material. Reactive precursors may be employed with known additive manufacturing techniques: selective laser melting (SLM), direct ink writing (DIW), etc.

In various configurations described herein, the precursor materials in the additive manufacturing process are not the material of the final product. For example, if the desired product is a structure comprised of boron nitride, the precursor materials may be a metal oxide (e.g., boron oxide) and an organic precursor that includes the desired component of the final product, (e.g., nitrogen). In this example, the organic precursor may be urea, which is comprised of nitrogen, carbon, and hydrogen.

According to one approach, the method begins with two or more precursor feedstocks, neither of which may be the final product. Precursor feedstocks are chosen such that when these precursor feedstocks are exposed to high-temperature, a chemical reaction will drive the mixture to the desired material product.

In various approaches, the precursor compounds are preferably non-reactive at room temperature, but may be non-reactive at slightly higher temperatures above room temperature, or slightly lower temperatures below room temperature. In some approaches, the precursor might be non-reactive in a solution (e.g., hexane, glycol, water, etc.). In various approaches, the organic precursor compound may be a gas, solid, liquid, or a combination thereof.

Moreover, according to the approaches described herein, a valuable, expensive product may be formed from fairly inexpensive precursor feedstocks, thus the methods described here simultaneously add the value of the chemistry as well as the formation of a complex, geometric shape.

In other approaches, metal oxides may be used as precursor feedstocks with an organic precursor feedstock to form other metal ceramics or metals. For example, in one approach, titanium oxide, TiO₂, which is non-reactive (e.g., stable) at room temperature, may be used to print/form complex structures of metal titanium, an expensive metal.

In conventional methods, AM printing involves powders of the metal, such that titanium powders are reactive and tend to degrade in air, thus it would be advantageous to fabricate titanium structures from the more stable and nonreactive TiO₂ rather than titanium powder.

According to various approaches described herein, complex geometric structures may be fabricated comprised of ceramic material. For example, but not meant to be limiting, compositions of ceramic material that are light weight, hard, resistant to temperature, etc., may include nitrides and carbides (e.g., boron nitride, boron carbide, silicon carbide, silicon nitride, titanium nitride, titanium carbide, etc.).

According to various approaches, reactive organic precursor material may include organic compositions in solid, liquid, or gas form that decompose at high temperatures thereby allowing one or more components to form the desired product with the metal oxide and the remaining components of the organic precursor are released as a gas. For example, a solid powder of urea may be used such that the nitrogen portion of the reaction that forms a product boron nitride comes from the organic compound (e.g., urea), and the remainder of the organic component turns into a gas. Organic compounds that may be included as prime feedstocks include compounds that would drive a chemical reaction at high temperatures and decompose to release a gas, for example, but not meant to be limiting in any way, methane, long chain hydrocarbon (e.g., octane, ethane, etc.), benzene rings, etc. Organic precursors are powerful tools, because these compounds can be a source of carbon, hydrogen and/or nitrogen, and they decompose to individual components at high temperatures. At high temperatures (e.g., greater than 1000° C.) most organic precursors tend to decompose instead of melt to become a liquid, and thus become carbon, hydrogen, and possibly nitrogen, (e.g., basic species for chemistry). A common long chain hydrocarbon mixed with metal (e.g., a metallic) is a butyl group attached to a metal (e.g., butyl titanium) as an organometallic material.

Temperatures for the chemical reaction may be up to 3000° C. (e.g., heated by a laser source, sintering during post processing in DIW, etc.) in at least some approaches described herein.

Organic compounds that are too carbon rich (e.g., acetylene) may be used for making carbide material, but not nitride material. The organic precursor may be tailored to have the right internal chemistry. In preferred approaches, an organic precursor may have a carbon bonded to hydrogen and nitrogen, so that when the precursor breaks down, a gas such as a methane, carbon monoxide, carbon dioxide, etc., may be released to liberate the hydrogen, nitrogen, etc.

In one approach, powdered boron oxide may be suspended in an aqueous solution of urea. Local laser-based heating interacting with the boron oxide heats the water, thus locally precipitating the urea from solution, providing the necessary precursor to react with the boron oxide to form boron nitride.

In some approaches, the chemical reaction at the elevated temperatures (e.g., laser, sintering, etc.) may be driven with at least one of the components being a liquid.

According to various approaches, conventional laser powder bed fusion additive manufacturing techniques may be used for the reactive chemistry of the precursor feedstocks. The lasers have scan parameters that can control how fast the laser moves during writing, the spot size of the laser (focusing optics), and the power output of the laser. These parameters may be optimized for the systems described herein. Moreover, in some approaches, the wavelength of the laser may be selected according to the desired process parameters. The wavelength of the laser may be a green laser, an infrared laser, etc. These approaches are presented by way of example and are not meant to be limiting in any way.

In some approaches, the process may be adapted to direct ink writing applied manufacturing techniques. An ink may be customized to include the reactive precursors, e.g., a metal oxide and organic precursor, in a jelly-like carrier of semi-solid consistency. The ink is fed through a nozzle and a structure (e.g., cylinder, log-pile, etc.) is printed by direct ink writing processes. Then, the structure of ink undergoes post-processing, which involves drying and/or heat treating (e.g., heating in a furnace) the material. In these processes, the post-processing treatment drives a chemical reaction to form the ceramic, metal, etc., material in the structure, and the decomposed components of the organic precursor are released as a gas. In some approaches, the decomposed components of the organic precursor may be a compound of the precursor (e.g., a carbon-rich precursor may form graphite in addition to the desired product) that is included in the printed structure of desired ceramic, metal, etc.

In some approaches, the additive manufacturing process allows control of the fabrication of metals and ceramics on a finer scale by tuning the reactive precursors according to the desired product. For example and not meant to be limiting in any way, for fabrication of a heterogeneous boron carbide network with graphite intermixed in the 3D geometric structure, a boron oxide precursor may be mixed with a carbon rich organic precursor (tuned to the specific product desired) to print a specific geometric shape (e.g., a cylinder of boron carbide with rods of graphite intermixed).

In some approaches, such as the case of selective laser melting, the heat source may be provided by a laser, and the heat induces a chemical reaction within the laser spot. As the laser spot moves across the surface of the precursors, the reaction is driven, and the product phase is interconnected by the continuity and heat diffusion of the laser path.

In one approach, a product includes a metallic and/or ceramic three-dimensional structure having physical characteristics of formation by additive manufacturing. Physical characteristics of formation by additive manufacturing may include a substantially flatter bottom surface (e.g., the lower layers of the printed structure including a first layer in contact with a printing platform) relative to a top surface (e.g., the upper layers of the printed structure). Physical characteristics may include a layered appearance and/or texture in some approaches (e.g., depending on the layer height). Other physical characteristics may include supporting materials, limited angles of the print (e.g., various AM techniques are limited to printing overhangs without support material to angles which are less than 45 degrees), relatively rougher surface finishes on overhangs, warping, higher concentration of materials at the bottom surface relative to a top surface, higher porosity at the bottom surface relative to a top surface, etc.

In various approaches, the structure may comprise any combination of metallic and/or ceramic materials described herein.

In one approach, the metallic and/or ceramic three-dimensional structure comprises hexagonal boron nitride, cubic boron nitride, boron carbide, silicon nitride, silicon carbide, silicon, titanium nitride, titanium, titanium carbide, molybdenum oxide, molybdenum, cerium, etc. In at least some approaches, a valuable, expensive product may be formed from fairly inexpensive precursor feedstocks. For example, in one approach, titanium oxide, TiO₂, which is non-reactive (e.g., stable) at room temperature, may be used to print/form complex structures of metal titanium, an expensive metal.

In a preferred configuration, the product comprises a structure having random porosity within filaments thereof. The random porosity is preferably random within each filament. It should be understood by one of ordinary skill in the art that the random porosity is not to be confused with the ordered and/or structured porosity consequent to the ordered creation of the filaments (e.g., the structural porosity characteristic of direct ink writing a log-pile).

Filaments as described herein may refer to reacted portions of the product which started life as an extruded filament in direct write printing, reacted portions formed along the path of the focused light for selective laser melting, etc. In one approach, a filament may refer to a portion of the structure eradicated by a laser (e.g., along the path of the laser).

In one approach, the structure has a gradient in composition along portions thereof. A gradient may include varying concentrations of precursors along the structure, varying porosities along the structure, varying concentrations of reacted portions along the structure, etc.

In one approach, the structure may comprise a shifted composition. For example, for a DIW process, an ink may comprise a carrier (e.g., graphite) and a first precursor (e.g., boron oxide). For a shifted composition, the first precursor may be gradually replaced with a second precursor (e.g., urea, a nitrogen source) such that the printed structure, in response to applying predefined conditions (e.g., sintering), comprises a grade of boron carbide to boron nitride. The printed structure comprises a mixture of the boron nitride and boron carbide where the second precursor gradually replaced the first precursor.

In a preferred approach, the structure has a gradient in porosity along portions thereof. A gradient in porosity may include a relatively higher porosity in at least one location along the structure.

In one configuration, the structure is at least 30 mol % elemental metal. The structure may be in a range between 30 and 70 mol % elemental metal. The structure may be at least 30 mol % elemental metal relative to other materials, e.g., such as a metal oxide. For example, the structure may be 30 mol % titanium, 70 mol % titanium oxide, etc. In various approaches, the structure may be 30 mol %, 35 mol %, 40 mol %, 45 mol %, 50 mol %, 55 mol %, 60 mol %, 65 mol %, 70 mol %, etc., elemental metal relative to other materials. In preferred approaches, the mol percentage of elemental metal is controllable during formation of the structure to create gradients and/or provide structural variations within the structure. The composition and/or physical characteristics of the structure are highly controllable by controlling the composition of the ink in various configurations described herein. The composition and/or physical characteristics of the structure are highly controllable by controlling the composition disclosed in various configurations described herein.

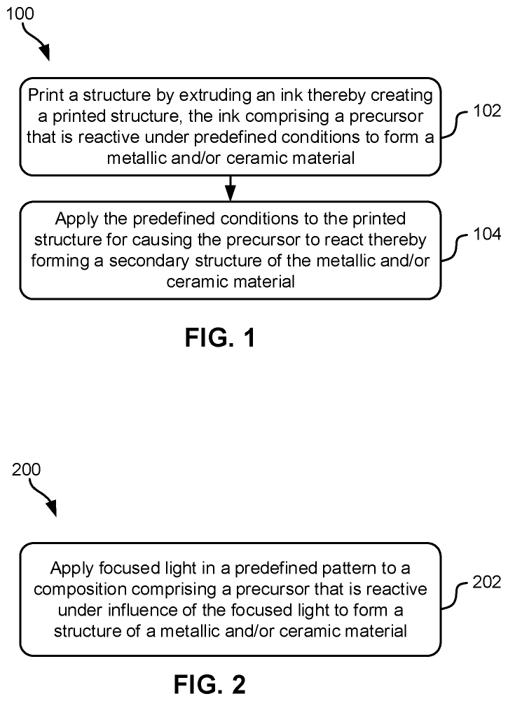

FIG. 1 shows a method 100, in accordance with one configuration. As an option, the present method 100 may be implemented to construct structures such as those shown in the other FIGS. described herein. Of course, however, this method 100 and others presented herein may be used to form structures for a wide variety of devices and/or purposes which may or may not be related to the illustrative configurations listed herein. Further, the methods presented herein may be carried out in any desired environment. Moreover, greater or fewer operations than those shown in FIG. 1 may be included in method 100, according to various configurations. It should also be noted that any of the aforementioned features may be used in any of the configurations described in accordance with the various methods.

According to approach, method 100 includes step 102 comprising printing a structure by extruding an ink thereby creating a printed structure, the ink comprising a precursor that is reactive under predefined conditions to form a metallic and/or ceramic material. In various approaches, the method 100 may be adapted to direct ink writing applied manufacturing techniques.

In various approaches, the ink comprises binders including any resins, waxes, semi-solvents, etc. Specifically, the ink may comprise wax, stearic acid, silicone, etc.

In various approaches, the precursor may be a compound, oxide, metallocene, gas, metal, etc. Specifically, the precursor may be boron oxide, urea, nitrogen, silica, graphite, titanium, borazine, silicon diimide, etc.

In at least some approaches, the ink may comprise more than one precursor. The ink may comprise at least two precursors which react with each other in response to the application of the predefined conditions to be discussed in detail below.

In one approach, the printed structure may comprise a functional gradient in composition. For example, the printed structure may be printed with an ink comprising a first precursor (e.g., boron oxide) and a second precursor (e.g., graphite). At a first end of the printed structure, the ink comprising both precursors prints the structure. As the printing progresses to a second end of the printed structure, the second precursor may deplete such that the ink comprises a higher concentration of the first precursor relative to the second precursor for printing the structure. Various predefined conditions may be applied to the printed structure to form a secondary structure. In this example, the secondary structure comprises the reacted boron oxide and graphite (e.g., boron carbide) at a first end of the secondary structure and a functional grade to boron oxide across the secondary structure to the second end of the secondary structure.

In one approach, the predefined conditions include raising a temperature of the printed structure to above a minimum reaction temperature for the precursor. The minimum reaction temperature may be readily determinable by one of ordinary skill in the art using known techniques and in consideration of the precursor and the intended final product. In various approaches, the intended final product is the secondary structure (to be described in detail below).

In another approach, the predefined conditions include an atmosphere having a reactant that reacts with the precursor for forming the secondary structure. The atmosphere having a reactant that reacts with the precursor may be a reducing atmosphere, an oxidizing atmosphere, an inert atmosphere, etc.

Step 104 includes applying the predefined conditions to the printed structure for causing the precursor to react thereby forming a secondary structure of the metallic and/or ceramic material. The predefined conditions may be any of the predefined conditions listed above. In any approach listed herein, the predefined conditions and/or the values thereof may be found in a look-up table.

In one approach, thermal treatment may be applied to the secondary structure. Thermal treatment may include calcining, sintering, annealing, smelting, etc. The thermal treatment may comprise heating the secondary structure for altering the porosity within the filaments. For example, the secondary structure may be sintered to increase the porosity within the filaments, within the structure, etc., as would be understood by one having ordinary skill in the art. In other approaches, the thermal treatment may comprise applying arc furnace heating to the secondary structure.

In a preferred approach, the secondary structure has a random porosity within filaments thereof. The random porosity is preferably random within each filament. It should be understood by one of ordinary skill in the art that the random porosity is not to be confused with the ordered and/or structured porosity consequent to the ordered creation of the filaments (e.g., the structural porosity characteristic of direct ink writing a log-pile).

Filaments as described herein may refer to reacted portions of the product which started life as an extruded filament in direct ink write printing, reacted portions formed along the path of the focused light for selective laser melting, etc. In one approach, a filament may refer to a portion of the structure eradicated by a laser (e.g., along the path of the laser).

In preferred configurations, the secondary structure is a high-temperature ceramic and/or metal. Specifically, the secondary structure is a hexagonal boron nitride, cubic boron nitride, boron carbide, silicon nitride, silicon carbide, silicon, titanium nitride, titanium, titanium carbide, etc. In various approaches, the structure may comprise any combination of metallic and/or ceramic materials described herein.

In one approach, the secondary structure may comprise a shifted composition. For example, for a DIW process, an ink may comprise a carrier (e.g., graphite) and a first precursor (e.g., boron oxide). For a shifted composition, the first precursor may be gradually replaced with a second precursor (e.g., urea, a nitrogen source) such that the secondary structure comprises a grade of boron carbide to boron nitride. The secondary structure comprises a mixture of the boron nitride and boron carbide in a location where the second precursor gradually replaced the first precursor. The ink may comprise one or more precursors wherein the ratios of the precursors may be adjusted throughout the printing operation of the structure.

In one approach, the method 100 may include changing a ratio and/or concentration of the precursor in the ink. Changing a ratio and/or concentration of the precursor in the ink may be relative to the one or more other components for creating gradients in composition in the secondary structure. A gradient may include varying concentrations of precursors along the secondary structure, varying porosities along the secondary structure, varying concentrations of reacted portions along the secondary structure, etc. In a preferred approach, the secondary structure has a gradient in porosity along portions thereof. A gradient in porosity may include a relatively higher porosity in at least one location along the secondary structure.

FIG. 2 shows a method 200, in accordance with one configuration. As an option, the present method 200 may be implemented to construct structures such as those shown in the other FIGS. described herein. Of course, however, this method 200 and others presented herein may be used to form structures for a wide variety of devices and/or purposes which may or may not be related to the illustrative configurations listed herein. Further, the methods presented herein may be carried out in any desired environment. Moreover, greater or fewer operations than those shown in FIG. 2 may be included in method 200, according to various configurations. It should also be noted that any of the aforementioned features may be used in any of the configurations described in accordance with the various methods.

According to approach, method 200 includes step 202 comprising applying focused light in a predefined pattern to a composition comprising a precursor that is reactive under influence of the focused light to form a structure of a metallic and/or ceramic material. The predefined pattern may be any three-dimensional shape with relatively complex geometries, relatively simple geometries, etc. The focused light may comprise a single laser beam focused to a focal point (e.g., a point of interest), multiple laser beams crossing at a focal point, a green laser, an infrared laser, a system of lens, refractors, and/or reflectors, aspheric lenses, etc. In various approaches, the method 200 may be adapted to selective laser melting applied manufacturing techniques.

In various approaches, the precursor may be a compound, oxide, metallocene, gas, metal, etc. Specifically, the precursor may be boron oxide, urea, nitrogen, silica, graphite, titanium, borazine, silicon diimide, Ti[N(CH₃)₂]₄ (TDMAT), ammonia, CeCl₃, Mo(CO)₆, graphite, etc.

In preferred approaches, the structure of a metallic and/or ceramic material is a high temperature ceramic and/or a metal. Specifically, the structure is a hexagonal boron nitride, cubic boron nitride, boron carbide, silicon nitride, silicon carbide, silicon, titanium nitride, titanium, titanium carbide, molybdenum oxide, molybdenum, cerium, etc. In various approaches, the structure may comprise any combination of metallic and/or ceramic materials described herein.

In one approach, method 200 includes changing characteristics of the light for creating a gradient in composition in the structure. Various lasers for SLM techniques have scan parameters which control how fast the laser moves during writing, the spot size of the laser (focusing optics), and the power output of the laser. These parameters (e.g., characteristics) may be optimized to create a gradient in composition in the structure. The wavelength of the focused light may be selected according to the desired process parameters. Other changeable characteristics may include intensity of the focused light, the laser beam radius, the melt zone radius, laser power, scan speed, hatch spacing, powder layer thickness, etc.

In one approach, thermal treatment may be applied to the structure. Thermal treatment may include calcining, sintering, annealing, smelting, etc. Thermal treatment may be applied to the structure for altering the porosity within the filaments. For example, the structure may be sintered to increase the porosity within the filaments, within the structure, etc., as would be understood by one having ordinary skill in the art. In other approaches, the thermal treatment may comprise applying arc furnace heating to the structure.

In a preferred approach, the structure has a random porosity within filaments thereof. The random porosity is preferably random within each filament. It should be understood by one of ordinary skill in the art that the random porosity is not to be confused with the ordered and/or structured porosity consequent to the ordered creation of the filaments (e.g., the structural porosity characteristic of direct ink writing a log-pile).

Filaments as described herein may refer to reacted portions of the product which started life as an extruded filament in direct write printing, reacted portions formed along the path of the focused light for selective laser melting, etc. In one approach, a filament may refer to a portion of the structure eradicated by a laser (e.g., along the path of the laser).

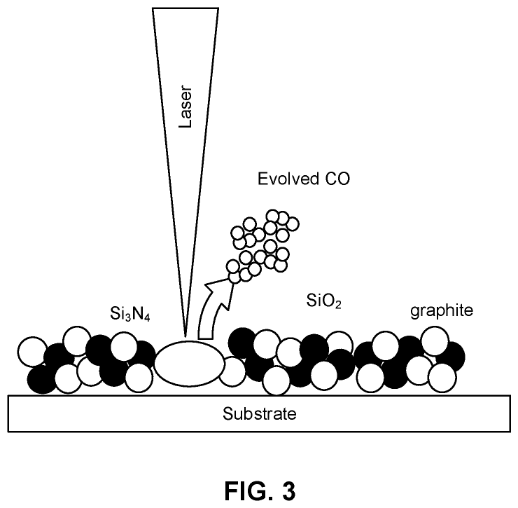

As shown in FIG. 3, reactive precursors silicon dioxide (SiO₂ or sand) and carbon (in this case, soot) in a nitrogen (N) atmosphere combined with additive manufacturing of a laser-directed heating may produce high value components (e.g., Si₃N₄) from inexpensive materials. In other approaches, an organic precursor is included as a nitrogen source, such as urea, and the laser process may proceed in air to form the Si₃N₄ from sand and soot reactive precursors.

In other approaches, the same reaction in FIG. 3 may be adapted to direct ink writing AM techniques by forming a custom ink of sand (SiO₂) and soot (C, graphite), forming a 3D structure of the custom ink, and heating the structure in a nitrogen atmosphere to form a structure of Si₃N₄. The reactive precursors may be mixed and dissolved in a suitable rheological ink. The ink can be extruded to print an oversized structure of appropriate proportions. The printed structure may undergo a post-processing heat treatment at elevated temperature to drive the chemical reaction of the precursors and sinter the component into a final shape of Si₃N₄.

### Experiments

Manufacturing boron nitride parts is difficult, because the solid is stable to high temperatures and does not readily melt to allow casting or molding techniques.

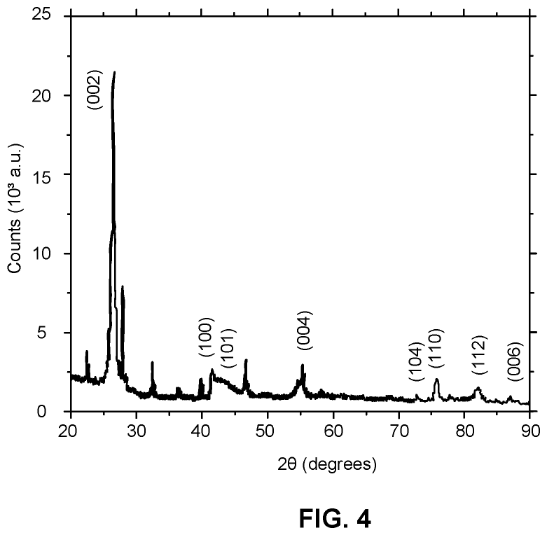

FIG. 4 shows an X-ray diffraction pattern of a boron nitride product generated from a furnace-heated enabled reaction of a mixture of boron oxide and urea. Labeled peaks are from hexagonal boron nitride. Unlabeled peaks are from cubic boron nitride.

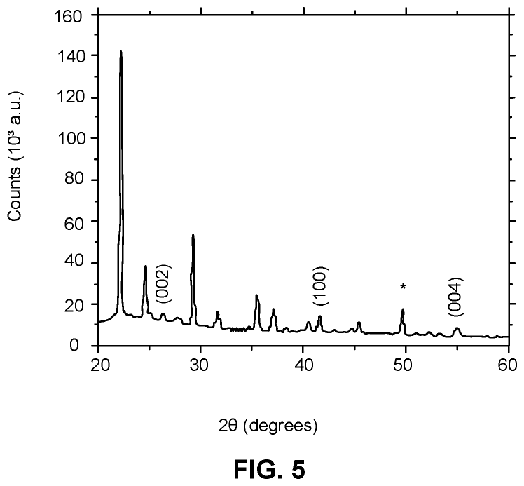

FIG. 5 shows X-ray diffraction results of the same powder mixture exposed to selective, localized laser heating, indicating at least a partial reaction to boron nitride under these conditions. Labeled peaks are from hexagonal boron nitride. Unlabeled peaks come from the starting urea and boron oxide powders in and around the reacted region.

Exemplary Reactions and Temperatures

3SiO₂+6C+2N₂↔Si₃N₄+6CO (T>1500 C) Reaction 1

Ti[N(CH₃)₂]₄+4NH₃→TiN+4HN(CH₃)₂+4H₂+1½N₂ Reaction 2

CeCl₃→Ce+1½Cl₂ Reaction 3

Mo(CO)₆→Mo+6CO Reaction 4

2B₂O₃+7C→B₄C+6CO (T>2000 C) Reaction 5

B₄C was produced according to Reaction 5 at low laser power (e.g., 50 W). The material denudation during SLM must be controlled.

SiO₂+nC→Si (or SiC) (T>1600 C) Reaction 6

2B₂O₃+7C→B₄C (T>2273 K) Reaction 7

SiO₂+3C→Si/SiC (T>1473 K) Reaction 8

Reaction 8 did not produce SiC due to a lack of excess C, but instead produced elemental Si.

Ti+C→TiC (T unknown) Reaction 9

Ti-6Al-4V+C(graphite)>˜70% TiC Reaction 10

2Ti+N₂→2TiN (T>1473 K) Reaction 11

TiN was produced according to Reaction 11 including a full reaction across the plate at 200 W laser power.

2B₂O₃+7C (N₂ atmosphere)→BN (T>2273 K) Reaction 12

BN formation was identified by X-ray powder diffraction (XRD) from reacting in an SLM system according to Reaction 12.

In other approaches, metal halides may be used as the reactive precursors in any of the methods described above. Metal halides include CeCl₃, CuCl₂, MoCl₄, LaCl₃, FeCl₃, CoCl₂, CeF₃, CuF₂, MoF₄, LaF₃, FeF₃, CoF₂, CeBr₃, CuBr₂, MoBr₄, LaBr₃, FeBr₃, CoBr₂, CeI₃, CuI₂, MoI₄, LaI₃, FeI₃, CoI₂, etc. Focused light techniques as presented herein may be used to fabricate reducing metals out of salts. Reducing metals typically vaporize quickly under heating conditions such that any mass is transported away from the reaction. In sharp contrast, SLM, for example, directs relatively high energy, relatively quickly at the precursors such that the reducing metal remains intact and is not lost to a vapor phase.

Uses

Current additive manufacturing research and development is primarily focused on metals. Thus, as described in various approaches herein, expanding additive manufacturing to include ceramic material would expand industrial use of ceramic components as structural material for lightweight, high-strength applications.

In general, metals may be reduced and/or formed by conventional methods including casting, forging, etc. Metals are typically highly reactive (e.g., powdered metals may react before the part is formed). Raw metal powders are not preferred materials for SLM processes where the reactivity of the powders results in significant impurities (e.g., 20% metal and 80% oxide).

In contrast, the oxidation effects of the reactive precursors and techniques presented herein make the concept of reactive precursors a preferable option with a smaller production footprint. An advantage of precursors implemented in DIW as presented herein is improved purity of the manufactured metals due to the containment of the precursor materials and uniform sintering such that there is a bias toward equilibrium.

Similarly, ceramics (e.g., Si₃N₄, B₄C, etc.) may be synthesized according to various reactions but conventional formation of ceramics is limited to pressing/sintering operations. For example, Si₃N₄ cannot be melt casted due to decomposition before melting. Also, SiC and B₄C melt near 2800 degrees C., making these compounds a tremendous challenge to cast. In sharp contrast, at least some of the approaches presented herein provide the ability to run reactions at a temperature which is below melt or decomposition. These reactions enable direct forming at relatively easily achievable temperatures.

The microscale, random porosity characteristics of the structures within a competent component produced by at least some of the operations disclosed herein are useful engineering features for light-weighting. In stark contrast, conventional melt casting and pressing/sintering methods fully consolidate materials and remove porosity.

According to various approaches described herein, the concept of reactive precursors may be applied to the simultaneous fabrication and synthesis of numerous materials including silicon nitride, boron nitride, metal-nitrides, metal-carbides, metals, etc.

The inventive concepts disclosed herein have been presented by way of example to illustrate the myriad features thereof in a plurality of illustrative scenarios, approaches, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various approaches have been described above, it should be understood that they have been presented by way of example only, and not limitation. Thus, the breadth and scope of an approach of the present disclosure should not be limited by any of the above-described exemplary approaches, but should be defined only in accordance with the following claims and their equivalents.

What is claimed is:

1. A product, comprising:
a metallic and/or ceramic three-dimensional structure having physical characteristics of formation by additive manufacturing,
the structure having random porosity within filaments thereof.

2. The product of claim 1, wherein the structure has a gradient in composition along portions thereof.

3. The product of claim 1, wherein the structure has a gradient in porosity along portions thereof.

4. The product of claim 1, wherein the structure is at least 30-70 mol % elemental metal.

5. A method, comprising:
printing a structure by extruding an ink thereby creating a printed structure, the ink comprising a precursor that is reactive under predefined conditions to form a metallic and/or ceramic material; and
applying the predefined conditions to the printed structure for causing the precursor to react thereby forming a secondary structure of the metallic and/or ceramic material.

6. The method of claim 5, wherein the predefined conditions include raising a temperature of the printed structure to above a minimum reaction temperature for the precursor.

7. The method of claim 5, wherein the predefined conditions include an atmosphere having a reactant that reacts with the precursor for forming the secondary structure.

8. The method of claim 5, comprising sintering the secondary structure.

9. The method of claim 5, wherein the secondary structure has a random porosity within filaments thereof.

10. The method of claim 5, comprising heating the secondary structure for altering the porosity within the filaments.

11. The method of claim 5, comprising changing a ratio of the precursor in the ink for creating a gradient in composition in the secondary structure.

12. The method of claim 5, wherein the precursor is selected from the group consisting of: boron oxide, urea, nitrogen, silica, graphite, titanium, borazine, and silicon diimide.

13. The method of claim 5, wherein the ink comprises at least two precursors that are reactive under the predefined conditions to form the metallic and/or ceramic material.

14. A method, comprising:
applying focused light in a predefined pattern to a composition comprising a precursor that is reactive under influence of the focused light to form a structure of a metallic and/or ceramic material.

15. The method of claim 14, comprising sintering the structure.

16. The method of claim 14, wherein the structure has a random porosity within filaments thereof.

17. The method of claim 14, comprising heating the structure for altering the porosity within the filaments.

18. The method of claim 14, comprising changing a characteristic of the light for creating a gradient in composition in the structure.

19. The method of claim 14, wherein the precursor is selected from the group consisting of: boron oxide, urea, nitrogen, silica, graphite, titanium, borazine, silicon diimide, TDMAT, ammonia, CeCl₃, Mo(CO)₆, and graphite.

20. The method of claim 14, wherein the composition comprises at least two precursors that are reactive under the predefined conditions to form the metallic and/or ceramic material.
